(19) United States
(12) Patent Application Publication
(10) Pub. No.: US 2014/0155084 A1
(43) Pub. Date: Jun. 5, 2014

(54) MULTI-MODE WIRELESS POSITION ASSOCIATION

(71) Applicant: QUALCOMM INCORPORATED, San Diego, CA (US)

(72) Inventor: Rayman Wai Pon, Cupertino, CA (US)

(73) Assignee: QUALCOMM Incorporated, San Diego, CA (US)

(21) Appl. No.: 13/692,918

(22) Filed: Dec. 3, 2012

(51) Int. Cl. H04W 4/02

(52) U.S. Cl. CPC H04W 4/02
USPC 455/456.1

(57) ABSTRACT

Position information obtained from a first wireless communication point may be associated with a second wireless communication point when signals are received from both the first and second wireless communication points, e.g., at or approximately at the same time. The wireless communication points may be, e.g., wireless network base station, access points, femto cells, etc. The position information may be a position for the first wireless communication point and a position uncertainty, which may be based on distances to the first and second wireless communication points, e.g., determined using wireless signal characteristics. The position information may be an uncertainty region determined based on position information from multiple wireless communication points. The position information associated with the second wireless communication point may be used in an application, e.g., obtaining a GPS position fix.

### BACKGROUND

1. Background Field

Embodiments of the subject matter described herein are related to using position information from a first wireless communication point with a second wireless communication point, and more specifically to generating a database that associates the position information with the second wireless communication point that can be used in applications, e.g., such as assisting in obtaining a position fix.

2. Relevant Background

A common means by which to derive a position fix for a mobile device is to determine the time required for signals transmitted from multiple sources at known locations to reach the mobile device. One system that provides signals from a plurality of communication points at known location is a satellite position system (SPS), such as the well-known Global Positioning Satellite (GPS) system, which employs a number of satellite vehicles that are in orbit around the Earth. A receiver in the mobile device receives the signals from the satellite vehicles and may process those signals to derive precise navigation information including three-dimensional position, velocity and time of day.

When an SPS receiver has already acquired satellite signals and has determined a position fix, the subsequent determination of a position is fast. However, when the SPS receiver is powered on, or brought out of a sleep mode, a first position fix must be performed. When the SPS receiver does not have valid almanac and ephemeris data, a search for the satellite signals must be performed. A search for satellite signals is greatly simplified, i.e., the range of search space is reduced, if an approximate position of the mobile device is already known. As position uncertainty for the mobile device decreases, the required space to be searched to obtain a satellite signal decreases.

Currently, various Wide Area Networks (WANs), e.g., CDMA, G, W, LTE, provide some form of country identifier as well as an optional Network Identity and Time Zone (NITZ), which can be used to provide a rough position of a receiving device. In large countries, such as the United States, the time zone position uncertainty is about 1000 Km, and the country position uncertainty is about 4000 Km. Some WANs, however, may provide a position of the serving cellular base station itself, which can be used as the basis for a coarse position of a mobile device receiving signals from the serving cellular tower. Currently, only some WANS using CDMA provide a position of some of the serving cellular base station, but possibly not all base stations. The use of the known position of the serving base station may be used as a coarse position for the mobile device with an uncertainty of approximately 50 Km or less, which provides a drastic reduction in the position uncertainty for SPS positioning purposes. Unfortunately, mobile devices connected to networks that do not broadcast the positions of serving cells, e.g., W, G, and LTE networks, suffer from the greater position uncertainty offered by the use of country codes or NITZ.

### SUMMARY

Position information obtained from a first wireless communication point may be associated with a second wireless communication point when signals are received from both the first and second wireless communication points, e.g., at the same time or approximately the same time. The wireless communication points may be, e.g., wireless network base station, access points, femto cells, etc. The position information may be a position for the first wireless communication point and a position uncertainty in a form of the combined ranges of the first and second wireless communication points or a position uncertainty for the second wireless communication point based on distances to the first and second wireless communication points, e.g., determined using wireless signal characteristics. The position information may be an uncertainty region determined based on position information from multiple wireless communication points. The position information associated with the second wireless communication point may be used in an application, e.g., to assist in obtaining an SPS position fix.

In one implementation, a method includes determining position information from a first wireless signal from a first wireless communication point; receiving a second wireless signal from a second wireless communication point; associating the position information with the second wireless communication point; and storing the position information associated with the second wireless communication point.

In one implementation, a mobile device includes a wireless interface capable of receiving a first wireless signal from a first wireless communication point and capable of communicating with a second wireless communication point; a storage element; and a processor coupled the storage element and the wireless interface, the processor configured to determine position information from the first wireless signal, associate the position information with the second wireless communication point, and to store the position information associated with the second wireless communication point in the storage element.

In one implementation, a mobile device includes means for determining position information from a first wireless signal from a first wireless communication point; means for receiving a second wireless signal from a second wireless communication point; means for associating the position information with the second wireless communication point; and means for storing the position information associated with the second wireless communication point.

In one implementation, a non-transitory computer-readable medium including program code stored thereon, includes program code to determine position information from a first wireless signal from a first wireless communication point; program code to receive a second wireless signal from a second wireless communication point; program code to associate the position information with the second wireless communication point; and program code to store the position information associated with the second wireless communication point.

In one implementation, a method includes receiving a first wireless signal from a first wireless communication point; retrieving position information associated with the first wireless communication point, wherein the position information associated with the first wireless communication point is based on position data broadcast by a second wireless communication point; and using the position information associated with the first wireless communication point in an application.

In one implementation, a mobile device includes a wireless interface capable of receiving a first wireless signal from a first wireless communication point; and a processor coupled the storage element and the wireless interface, the processor configured to retrieve position information associated with the first wireless communication point, wherein the position information associated with the first wireless communication point is based on position data broadcast by a second wireless communication point, and use the position information associated with the first wireless communication point in an application.

In one implementation, a mobile device includes means for receiving a first wireless signal from a first wireless communication point; means for retrieving position information associated with the first wireless communication point, wherein the position information associated with the first wireless communication point is based on position data broadcast by a second wireless communication point; and means for using the position information associated with the first wireless communication point in an application.

In one implementation, a non-transitory computer-readable medium including program code stored thereon, includes program code to receive a first wireless signal from a first wireless communication point; program code to retrieve position information associated with the first wireless communication point, wherein the position information associated with the first wireless communication point is based on position data broadcast by a second wireless communication point; and program code to use the position information associated with the first wireless communication point in an application.

In one implementation, a method includes receiving from a remote mobile device position information obtained from a first wireless communication point and an identification of a second wireless communication point that is accessed by the remote mobile device; associating the position information obtained from the first wireless communication point with the second wireless communication point; and storing the position information associated with the second wireless communication point.

In one implementation, a server includes an external interface for communication with remote mobile devices; a storage element; and a processor coupled to the external interface and the storage element, the processor configured to receive from a remote mobile device through the external interface position information obtained from a first wireless communication point and an identification of a second wireless communication point that is accessed by the remote mobile device; associate the position information obtained from the first wireless communication point with the second wireless communication point; and store the position information associated with the second wireless communication point in the storage element.

In one implementation, a server includes means for receiving from a remote mobile device position information obtained from a first wireless communication point and an identification of a second wireless communication point that is accessed by the remote mobile device; means for associating the position information obtained from the first wireless communication point with the second wireless communication point; and means for storing the position information associated with the second wireless communication point.

In one implementation, a non-transitory computer-readable medium including program code stored thereon, includes program code to receive from a remote mobile device position information obtained from a first wireless communication point and an identification of a second wireless communication point that is accessed by the remote mobile device; program code to associate the position information obtained from the first wireless communication point with the second wireless communication point; and program code to store the position information associated with the second wireless communication point.

### BRIEF DESCRIPTION OF THE DRAWING

FIG. 1 illustrates a mobile device capable of multi-mode position association, in which position information of a first wireless communication point is associated with second wireless communication point.

FIG. 2 illustrates database entries that may be used with multi-mode position association.

FIG. 3 illustrates determining position uncertainty for the second wireless communication point based on distances from the first and second wireless communication points.

FIG. 4 illustrates determining an uncertainty region for the second wireless communication point based on position information from multiple wireless communication points.

FIG. 5A illustrates flow chart of a method of generating a database that associates position information from a first wireless communication point to a second wireless communication point.

FIG. 5B is a flow chart, similar to FIG. 5A, in which the method further includes determining additional position information for other wireless communication points.

FIG. 6 is a flow chart of a method of determining position uncertainty for the second wireless communication point based on distances from the first and second wireless communication points.

FIG. 7 is a flow chart of a method of determining an uncertainty region for the second wireless communication point based on position information from multiple wireless communication points.

FIG. 8 is a flow chart of a method of using the stored the position information associated with a wireless communication point in an application.

FIG. 9 is a block diagram of a mobile device capable of using position information from a first wireless communication point with a second wireless communication point.

FIG. 10A is a flow chart of a method of generating a database of position information with a server.

FIG. 10B is a flow chart of another method of generating a database of position information with the server.

FIG. 11 is a flow chart of a method to determine an uncertainty region for the second wireless communication point based on position information from a plurality of wireless communication points.

FIG. 12 is a block diagram of a server capable using position information from a first wireless communication point with a second wireless communication point.

### DETAILED DESCRIPTION

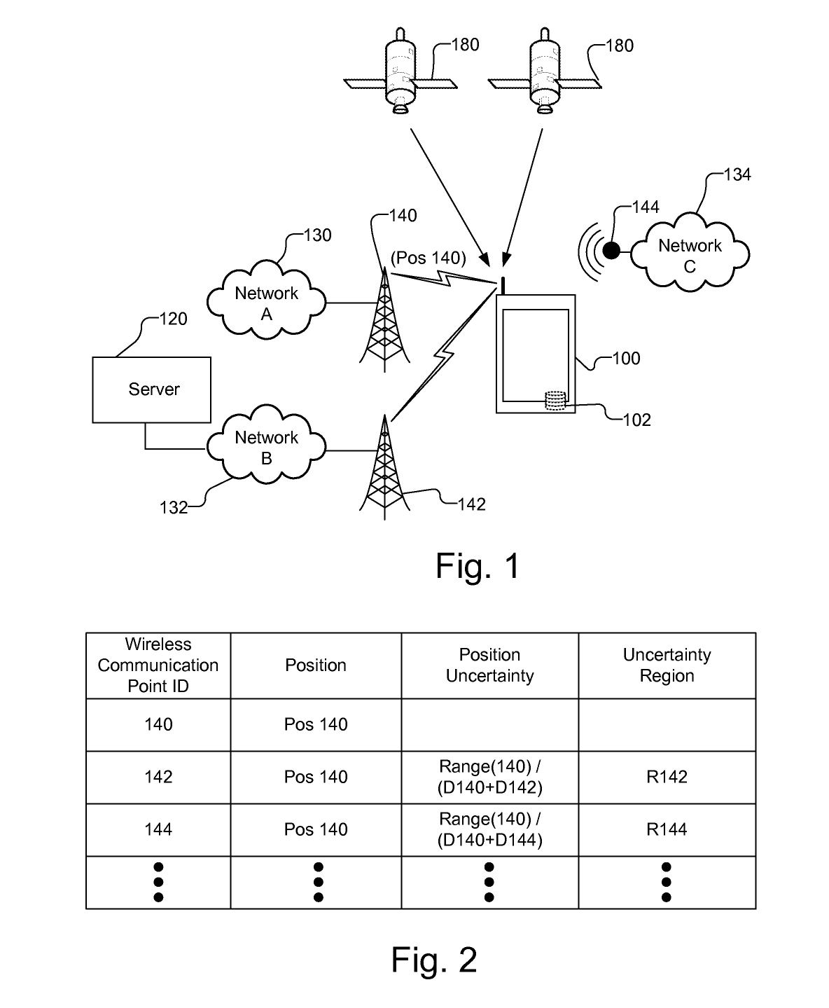

FIG. 1 illustrates a mobile device 100 capable of multi-mode WAN position association, in which the position of a first wireless communication point is associated with a second wireless communication point. The wireless communication points may be, i.e., in the same or different wireless networks. The mobile device 100 may be a multi-mode device such as a cellular or other wireless communication device, personal communication system (PCS) device, personal navigation device (PND), Personal Information Manager (PIM), Personal Digital Assistant (PDA), laptop or other suitable mobile device which is capable of receiving wireless communication and/or navigation signals. The term “mobile device” is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile station” is intended to include all devices, including wireless communication devices, computers, laptops, etc. which are capable of communication with a server, such as via the Internet, WiFi, cellular wireless network or other network, and regardless of whether satellite signal reception, assistance data reception, and/or position-related processing occurs at the device, at a server, or at another device associated with the network. Any operable combination of the above are also considered a “mobile station.”

As illustrated, the mobile device 100 may communicate with a first wireless communication point 140, which may be in a first wireless network A 130, and which may be, e.g., a cellular base station. Along with other information, such as NITZ, the network A 130 also provides a position (Pos 140) for the wireless communication point 140, which is received by the mobile device 100. The network A 130 may be any wireless network that provides position information for the serving wireless communication point 140, e.g., CDMA.

Mobile device 100 may additionally communicate with a second wireless communication point 142, which may be in a second wireless network B 132, and which may be, e.g., another cellular base station. The mobile device 100 communications with the second wireless network B 132, which may be at the same time or approximately the same time as communicating with the first wireless network A 130. Wireless network B 132 may provide information such as Network Identity and Time Zone (NITZ), but does not provide a position for the wireless communication point 142. For example, wireless network may be W, G, or LTE networks. Additionally, as illustrated, mobile device 100 may communicate with other communication points, such as a third wireless communication point, which may be in a different wireless network, and which may be, e.g., a WiFi access point, femto cell, or other wireless communication point. Similar to wireless network B 132, wireless network C 134 does not provide a position for the wireless communication point 144.

The mobile device 100 associates the position (Pos 140) of the first wireless communication point 140 with the second wireless communication point 142, which is stored in a database, e.g., an on-board database 102 and/or the data may be transmitted to the server 120 for storage in a remote database. Thus, the position (Pos 140) serves as a coarse position of the second wireless communication point 142. In addition to the position (Pos 140), a position uncertainty may be determined and associated for the second wireless communication point 142. The position uncertainty may be, e.g., the range of the first wireless communication point 140 summed with the range of the second wireless communication point 142, i.e., if the mobile device 100 communicates with both the first wireless communication point 140 and the second wireless communication point 142 at the same time or approximately the same time, then the second wireless communication point 142 is located a distance from the first wireless communication point that is no more than the range of the second wireless communication point 142 plus the range of the first wireless communication point 140. Thus, for example, if the ranges of the first wireless communication point 140 and the second wireless communication point 142 are 50 km or less, then the position uncertainty for the second wireless communication point 142 may be 100 km from the position of the first wireless communication point 140. An uncertainty of 100 km is relatively useful position uncertainty for assisting in obtaining a position fix, e.g., searching for satellites in SPS 180, or for other applications, such as geofencing or obtaining local weather conditions. Alternatively, a more accurate position uncertainty may be generated, e.g. based on determined distances from the first wireless communication point 140 and the second wireless communication point 142. As will be understood in light of the present disclosure, a communication with the first wireless communication point 140 and the second wireless communication point 142 will be considered to be at approximately the same time if the separation in time is sufficiently short that the position uncertainty may be relied upon, e.g., the mobile device 100 could not have traveled a significant distance with respect to the position uncertainty.

Mobile device 100 may similarly associate the position (Pos 140) of the wireless communication point 140 for wireless network A 130 with the wireless communication point 144 for wireless network C 134 if mobile device 100 is in communication with both at the same time or close in time. The position (Pos 140) associated with the wireless communication points may be stored in a database 102 along with a position uncertainty, which may be collectively referred to as a coarse position.

FIG. 2, by way of example, illustrates database entries including the wireless communication point identifier (ID) determined by the mobile device and would ideally be globally unique, indicated by reference numerals 140, 142 and 144, and the position associated with the wireless communication points, i.e., Pos 140. FIG. 2 further illustrates associating position uncertainty with the wireless communication point ID. As illustrated, the position uncertainty associated with the wireless communication points 142 or 144 may be the range (Range 140) of the first wireless communication point 140. If desired, a different position uncertainty may be used, such as an uncertainty based on determined distance D140 from the first wireless communication point 140 and the distances D142, D144 from the second and third wireless communication points 142, 144. Additionally, as discussed below, an uncertainty region (R142) may be determined for the wireless communication point 142 (as well as wireless communication point 144) if there are a plurality of associated positions and position uncertainties obtained from a number of wireless communication points in wireless network A 130. It should be noted that obtaining the coarse position for a wireless communication point 142, 144 in this fashion is completely independent of SPS.

The mobile device 100 may store the database 102 or upload the database 102 to a server 120 for later usage by the mobile device 100 or any other mobile devices that later happens to be in contact with the wireless communication points 142 or 144. The server 120 is illustrated as coupled to network B 132, as mobile device 100 may communicate with the server 120 while connected to network B 132, but it should be understood that server 120 may be accessed through any network including, e.g., network A 130 and network C 134. The position information associated with wireless communication points 142 or 144 may be used, e.g., to search for satellites 180 in a satellite position system. The server 120 may crowdsource position information from a number of mobile devices and use the position information to generate a more refined position for each wireless communication point.

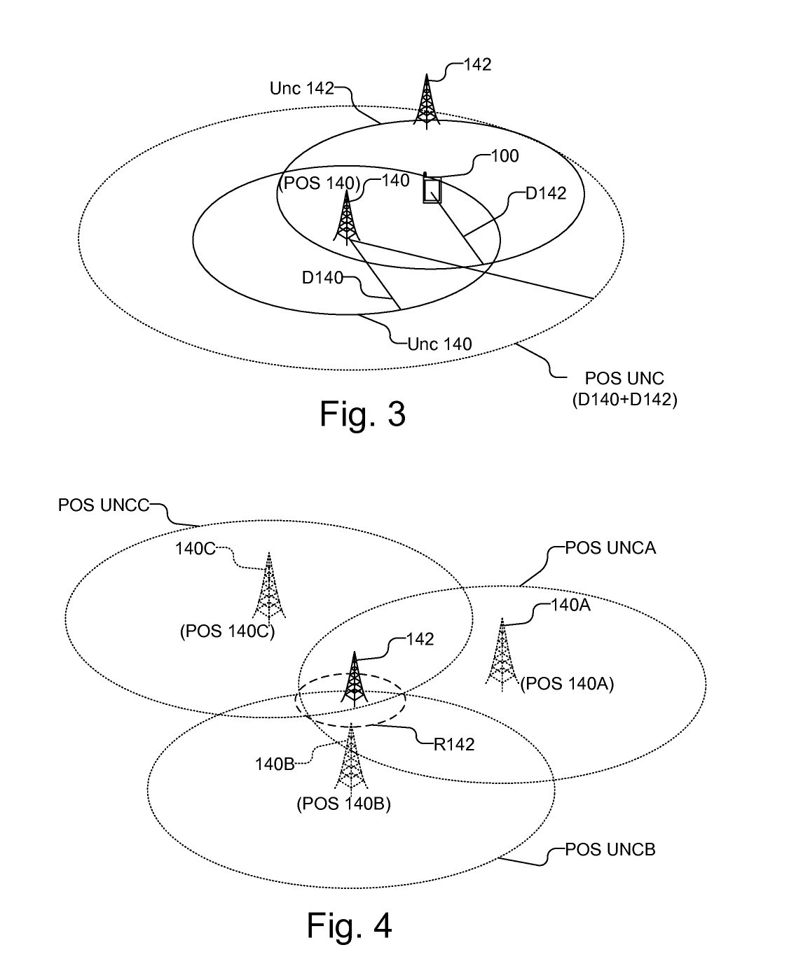

As discussed above, rather than using the range of the first wireless communication point 140 summed with the range of the second wireless communication point 142 as a position uncertainty, a more accurate position uncertainty may be determined based on the distances to the wireless communication points and associated with the second wireless communication point 142. The estimated distances to the wireless communication points 140, 142 may be determined based on the received signal strength indication (RSSI) along with a signal power model, and/or signal travel time. For example, as illustrated in FIG. 3, by measuring the RSSI (or travel time) for a wireless signal from wireless communication point 140, an estimated distance D140 from the mobile device 100 to the wireless communication point 140 may be determined. Thus, the position of the mobile device 100 with respect to the wireless communication point 140 can be estimated with an uncertainty (Unc 140) having a radius D140 about the position of the wireless communication point 140 (Pos 140). Similarly, a distance D142 from the mobile device 100 to the second wireless communication point 142 can be estimated based on the RSSI (or travel time) of a signal from the wireless communication point 142. The position of the second wireless communication point 142, however, is unknown, and, thus, the uncertainty Unc142 is illustrated as being centered on the mobile device 100. As there is no further information for the second wireless communication point 142, a worst case should be assumed and the uncertainty Unc 142 based on the distance 142 is added to the uncertainty Unc 140 with the distance D140 for the first wireless communication point 140 to produce the position uncertainty (POS UNC) for the second wireless communication point 140, which is the sum of the distances D140+D142) centered on the position (Pos 140) of the first wireless communication point 140. Thus, the position uncertainty associated with the second wireless communication point 142 may be greatly reduced from an uncertainty based on the ranges of the first wireless communication point 140 and the second wireless communication point 140.

To be conservative, the estimated distances produced from the signal power model should be large enough to ensure that the second wireless communication point is included in the estimated position uncertainty POS UNC. With a large database of associated wireless communication points, e.g., in the mobile device 100 or in the server 120, a good estimate for the coarse position of the second wireless communication point may be produced. Additionally, outliers may be identified and removed, such as when a signal is received much farther than the model would predict due to good propagation such as in the night time.

Moreover, as illustrated in FIG. 4, an uncertainty region for the second wireless communication point 142 may be determined based on position information associated with the second wireless communication point 142 that is derived from multiple first wireless communication points 140A, 140B, 140C (collectively 140) associated with the first network 130 (or other networks). As illustrated in FIG. 4, the second wireless communication point 142 has three associated coarse positions, illustrated as a position uncertainty (POC UNCA) around the position (POS 140A) of a wireless communication point 140A, a position uncertainty (POC UNCB) around the position (POS 140B) of a another wireless communication point 140B, and a position uncertainty (POC UNCC) around the position (POS 140C) of another wireless communication point 140C. The position uncertainties (POS UNCA, POS UNCB, and POS UNCC) may be based on the ranges of the wireless communication points or based on distances to the wireless communication points as discussed above, or any other method of determining a position uncertainty. As illustrated in FIG. 4, the position uncertainties (POS UNCA, POS UNCB, and POS UNCC) form an area of overlap around the second wireless communication point 142. The area of overlap of the uncertainties defines an estimated uncertainty region R142 for the second wireless communication point 142. For clarity, the uncertainty region R142 is illustrated in FIG. 4 as a circle that encloses the overlap region produced by the position uncertainties (POS UNCA, POS UNCB, and POS UNCC), but if desired, the uncertainty region R142 may be defined as only the area with overlapping position uncertainties. The uncertainty region R142 is a further reduction in the position uncertainty for the second wireless communication point 142. The estimation of the uncertainty region R142 may be performed by, e.g., by the mobile device 100, or by the server 120 using crowd sourced information provided by various mobile devices.

Thus, during development of the database, the mobile device 100 may store in its internal database 102 and/or transmit to the server 120 the wireless communication point IDs, along with the coarse position, e.g., position and position uncertainty and/or uncertainty region, associated with wireless communication points. Additionally, it may be desirable to store in the database 102 and/or transmit to the server 120, the RSSI and/or travel time information, or any other position uncertainty data that may be used to assist in determining position uncertainty. With such information, the position estimation may be improved and refined over time as more data points are obtained, e.g., by the mobile device or from crowdsourcing.

Additionally, it may be desirable to store or transmit position uncertainty data, such as RSSI and/or travel time information, for any set of two or more wireless communication points in which simultaneous or near simultaneous communications occur, even if the wireless communication points have no associated coarse position information. If the database already includes stored position information for any wireless communication point in the set of wireless communication points, the coarse positions for the remaining wireless communication points may then be determined, as discussed above.

Moreover, even if the database does not currently include position information for any of the wireless communication points in the set, the position uncertainty data, e.g., the RSSI and/or travel time information or a determined distance, should be retained in the database so that in the future, when position information is obtained for one of the wireless communication points in the set, the coarse positions for the remaining wireless communication points in the set may also be determined. Further, two or more different sets of wireless communication points may be linked together based on at least one wireless communication point that is common to the sets. Thus, the generation of a course position for one set of wireless communication points may be extended to other sets of wireless communication points using wireless communication points that are common between the sets.

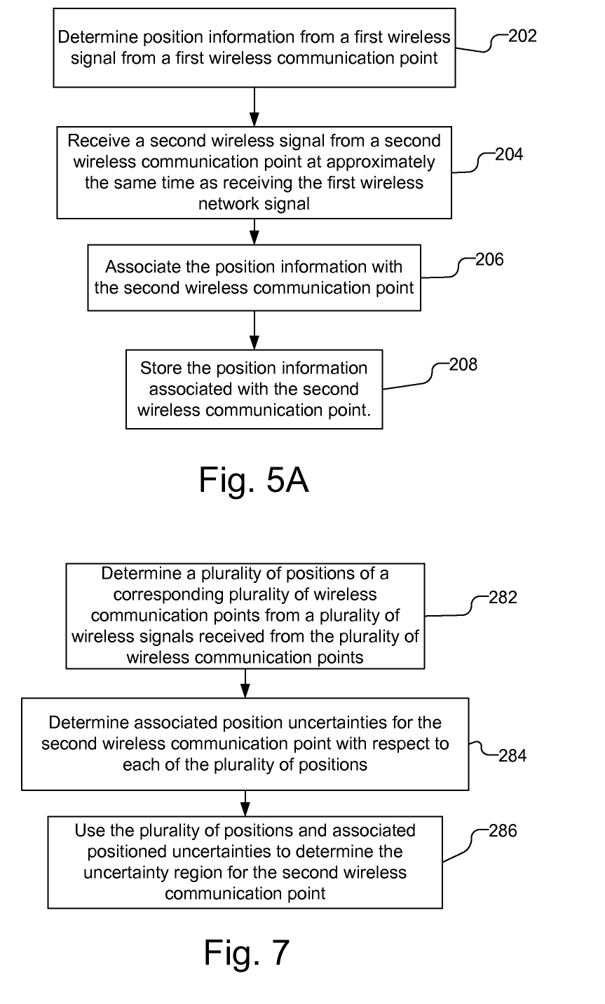

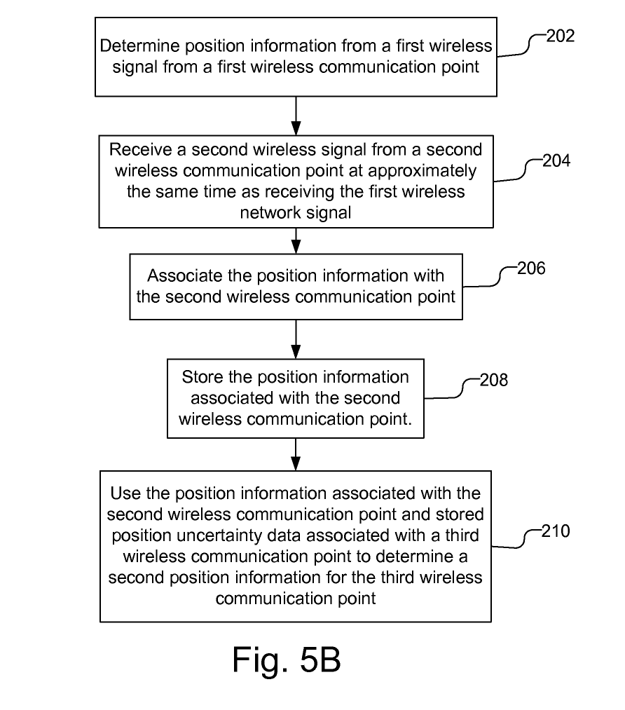

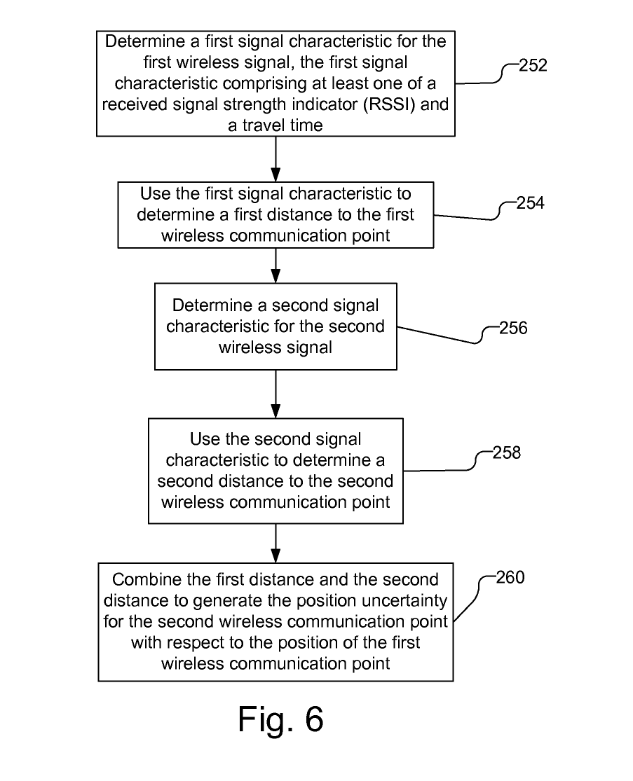

FIG. 5A, by way of example, illustrates a flow chart of a method of generating a database that associates position information from a first wireless communication point to a second wireless communication point. The method includes determining position information from a first wireless signal from a first wireless communication point (202). The first wireless communication point may be, e.g., a cellular base station, access point, femto cell or any other communication point. The position information for the first wireless communication point may be determined using a database or it may be contained within the wireless signal. The position information may include a position for the first wireless communication point and a position uncertainty for the second wireless communication point with respect to the position for the first wireless communication point. The position uncertainty for the second wireless communication point with respect to the position for the first wireless communication point may be, e.g., the approximate range of the first wireless communication point combined, e.g., summed, with the approximate range of the second wireless communication point, which may be 50 km+50 km=100 km or less. Alternatively, a more accurate position uncertainty for the second wireless communication point may be determined based on determined distances to the first wireless communication point and the second wireless communication point, as discussed in FIG. 6 below. Additionally, or alternatively, the position information may be an uncertainty region, as discussed in FIG. 7 below.

A second wireless signal is received from a second wireless communication point (204). The second wireless signal may be received at approximately the same time as the first wireless signal. The second wireless communication point may be, e.g., a cellular base station, access point, femto cell or any other communication point. The first wireless communication point and the second wireless communication point may be in the same or different wireless networks. For example, the first wireless network may broadcast the position information for the wireless communication points, while the second wireless network may not broadcast potion information for the wireless communication points. The position information is associated with a second wireless communication point (206) and stored (208). If desired, the position information associated with the wireless communication point may be uploaded to a server, which is remote from the wireless device.

FIG. 5B is another flow chart, similar to FIG. 5A, like designated elements being the same. As illustrated in FIG. 5B, the method may further include using the position information associated with the second wireless communication point and stored position uncertainty data associated with a third wireless communication point to determine a second position information for the third wireless communication point (210). For example, where the position information associated with the second wireless communication point includes a position for the first wireless communication point and a position uncertainty for the second wireless communication point with respect to the position for the first wireless communication point, the second position information may include the position for the first wireless communication point and a second position uncertainty for the third wireless communication point. The second position uncertainty may be based on the position uncertainty for the second wireless communication point and a third distance to the third wireless communication point determined using position uncertainty data, such as received signal strength indicator (RSSI) and a travel time.

As illustrated in FIG. 6, a position uncertainty for the second wireless communication point with respect to the position of the first wireless communication point may be determined based on distances to the first wireless communication point and the second wireless communication point. Thus, for example, a first signal characteristic is determined for the first wireless signal (252). The first signal characteristic may be, e.g., received signal strength indicator (RSSI) or a travel time of the signal. The first signal characteristic is used to determine a first distance to the first wireless communication point (254). For example, a signal power model may be used to estimate the distance. By way of example, as illustrated in FIG. 3, using RSSI or travel time, a distance D140 to the wireless communication point 140 can be determined. A second signal characteristic is determined for the second wireless signal (256), where the second wireless signal is received at the same time or substantially the same time as the first wireless signal. The second signal characteristic is used to determine a second distance to the second wireless communication point (258). Again referring to FIG. 3, using RSSI or travel time, a distance D142 to the wireless communication point 142 can be determined. The first distance and the second distance are combined to generate the position uncertainty for the second wireless communication point with respect to the position of the first wireless communication point (260), which is illustrated in FIG. 3 as POS UNC centered on the wireless communication point 140. Thus, the position uncertainty associated with the second wireless communication point may be greatly reduced related to the range of the first wireless communication point 140.

The position information determined from a first wireless signal (202 in FIG. 5A) may be an uncertainty region for the second wireless communication point as illustrated in FIG. 4, where position information from multiple wireless communication points is combined. FIG. 7 is a flow chart illustrating a method of determining the uncertainty region. As illustrated, a plurality of positions of a corresponding plurality of wireless communication points is determined from a plurality of wireless signals received from the plurality of wireless communication points (282). In other words, the position of the first wireless communication point as well as the position of a number of other wireless communication points is determined from the received wireless signals. Associated position uncertainties are determined for the second wireless communication point with respect to each of the plurality of positions (284). The position uncertainties may be determined as discussed above. Using the plurality of positions and associated positioned uncertainties, the uncertainty region for the second wireless communication point is determined (286), e.g., as the overlap area as illustrated in FIG. 4.

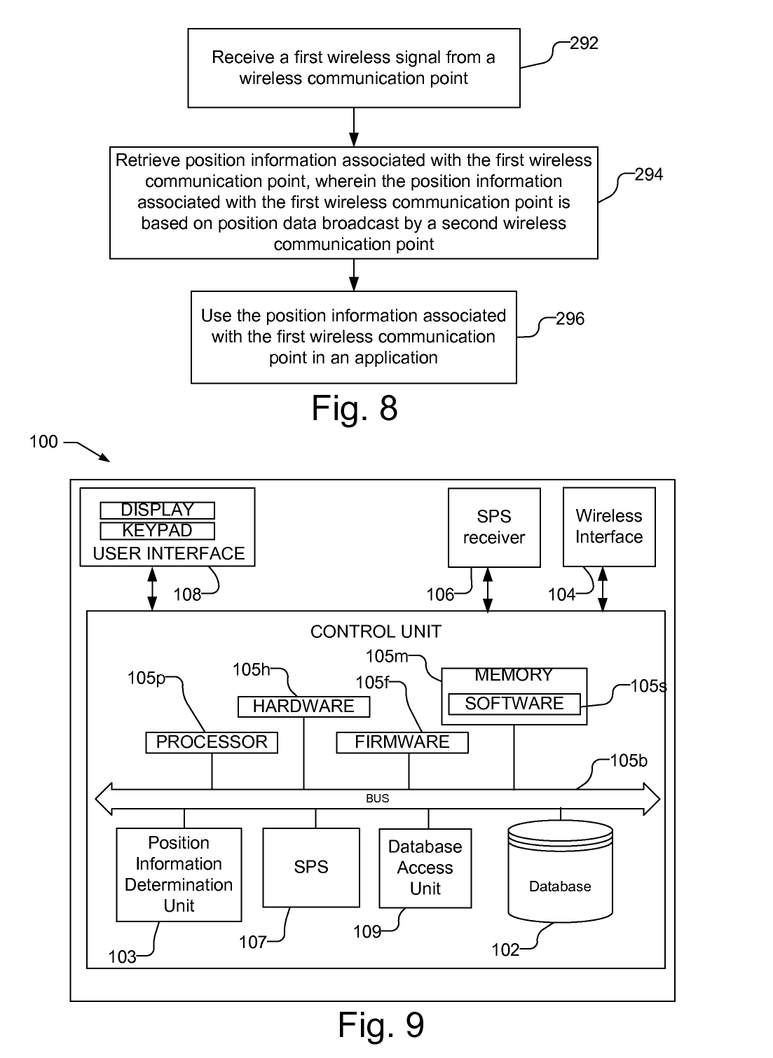

With the position information associated with a wireless communication point stored, either locally in the mobile device 100 or with a server 120, the position information may be retrieved and used in an application. For example, the position information may be used to assist in obtaining a position fix, or may be used in other applications, such as geofencing or obtaining local weather conditions, etc. FIG. 8, for example, illustrates a method of using the stored the position information associated with a wireless communication point in an application. As illustrated, a first wireless signal is received from a wireless communication point in a first wireless network (292). Position information associated with the first wireless communication point is retrieved (294). The position information associated with the first wireless communication point is based on position data broadcast by a second wireless communication point. The second wireless communication point may be in the same or different wireless network as the first wireless communication point. The position information may be retrieved, for example, from one of a local database and a server. The first wireless communication point and the second wireless communication point may be, e.g., a wireless network base station, an access point, and/or a femto cell. The position information may include a position for the second wireless communication point and a position uncertainty for the first wireless communication point with respect to the position second wireless communication point. Additionally or alternatively, the position information may include an uncertainty region defined by a plurality of positions for a plurality of wireless communication points and a plurality of position uncertainties for the first wireless communication point with respect to the plurality of positions. The position information associated with the first wireless communication point is used in an application (296). For example, the position information may be used in an application to obtain a position fix, e.g., the position information associated with first wireless communication point may be used to assist in the search for satellites in a satellite position system. The position information may be used for other applications, such as geofencing, obtaining local weather conditions or any other desired application that may use an approximate position.

FIG. 9 is a block diagram of a mobile device 100 capable using position information from a first wireless communication point with a second wireless communication point, e.g., to generate a database that associates the position information with the second wireless communication point and/or to use the stored position information associated with the second wireless communication point in an application, such as obtaining a position fix. As illustrated, the mobile device 100 includes a wireless interface 104 that may be used to receive and/or transmit data to the wireless communication points 140, 142, as well as server 120, shown in FIG. 1.

The wireless interface 104 may be used in any various wireless communication networks such as a wireless wide area network (WWAN), a wireless local area network (WLAN), a wireless personal area network (WPAN), and so on. The term “network” and “system” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, Long Term Evolution (LTE), and so on. A CDMA network may implement one or more radio access technologies (RATs) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth® network, an IEEE 802.15x, or some other type of network. Moreover, any combination of WWAN, WLAN and/or WPAN may be used.

The mobile device 100 may further include an SPS receiver 106 that may be used to search for satellites in an SPS system 180 and to receive position data from SPS system 180, which may be used to determine a position fix of the mobile device 100, as discussed above. The mobile device 100 may be, e.g., an A-GPS device or a standalone GPS device. The SPS receiver 106 may be capable of receiving signals from transmitters on satellite vehicles (SV) in a constellation of Global Navigation Satellite System (GNSS) such as Global Positioning System (GPS), Galileo, Glonass or Compass. The SPS receiver 106, however, is not restricted to global systems (e.g., GNSS) for SPS. For example, the various regional systems may be accessed, such as, e.g., Quasi-Zenith Satellite System (QZSS) over Japan, Indian Regional Navigational Satellite System (IRNSS) over India, Beidou over China, etc., and/or various augmentation systems (e.g., an Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein an SPS may include any combination of one or more global and/or regional navigation satellite systems and/or augmentation systems, and SPS signals may include SPS, SPS-like, and/or other signals associated with such one or more SPS.

The mobile device 100 may further include a user interface 108 that may include e.g., a display, as well as a keypad or other input device through which the user can input information into the mobile device 100.

The mobile device 100 also includes a control unit 105 that is connected to and communicates with the wireless interface 104 and SPS receiver 106. The control unit 105 receives and processes the wireless signals via wireless interface 104 received from the first wireless communication point 140 to determine position information. The control unit 105 additionally receives and processes data from the SPS receiver 106 and may control the wireless interface 104 to communicate with the server 120 via the wireless interface 104. The control unit 105 may be provided by a bus 105b, processor 105p and associated memory 105m, hardware 105h, firmware 105f, and software 105s. The control unit 105 is further illustrated as including a database 102, which may be the storage element for storing position information, or alternatively, memory 105m may be used to store the position information, e.g., while uploading the position information to a server 120 (FIG. 1) using the wireless interface 104. The control unit 105 further includes a position information determination unit 103, which may determine the position information from the wireless signal received through the wireless interface 104. For example, the position information determination unit 103 may determine the position of the wireless communication point from the received wireless signal. The position information determination unit 103 may further determine a position uncertainty from the wireless signal, e.g., the combined ranges of the wireless communication points, or may determine a position uncertainty based on distances to the first wireless communication point and the second wireless communication point, e.g., using a measured RSSI and/or travel time, and a signal power model. The position information determination unit 103 may further determine an uncertainty region for a wireless communication point using a plurality of positions and associated positioned uncertainties as discussed above. The position information determination unit 103 may determine an identity of a wireless communication point and retrieve the position information from the database 102, e.g., using database access unit 109. The database access unit 109 may associate determined position information from a first wireless communication point with the identify of a second wireless communication point and store the position information associated with the second wireless communication point in the database 102. The control unit 105 may further include an SPS unit 107 that uses SPS receiver 106 to determine a position fix for the mobile device 100 and that uses determined position information to assist in obtaining the position fix with the SPS receiver 106.

The position information determination unit 103, database access unit, 109 and SPS unit 107 are illustrated separately from processor 105p for clarity, but may be part of the processor 105p or implemented in the processor based on instructions in the software 105s which is run in the processor 105p. It will be understood as used herein that the processor 105p can, but need not necessarily include, one or more microprocessors, embedded processors, controllers, application specific integrated circuits (ASICs), digital signal processors (DSPs), and the like. The term processor is intended to describe the functions implemented by the system rather than specific hardware. Moreover, as used herein the term “memory” refers to any type of computer storage medium, including long term, short term, or other memory associated with the mobile device, and is not to be limited to any particular type of memory or number of memories, or type of media upon which memory is stored.

The methodologies described herein may be implemented by various means depending upon the application. For example, these methodologies may be implemented in hardware 105h, firmware 105f, software 105s, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in memory 105m and executed by the processor 105p. Memory 105m may be implemented within or external to the processor 105p. If implemented in firmware and/or software, the functions may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Thus, the mobile device 100 includes a means for determining position information from a first wireless signal from a first wireless communication point, which may include, e.g., the wireless interface 104, the position information determination unit 103 and/or the database access unit 109 and/or processor 105p using program code stored in memory 105m and database 102 or server 120. Means for receiving a second wireless signal from a second wireless communication point may include, e.g., the wireless interface 104. Means for associating the position information with the second wireless communication point may include, e.g., database access unit 109 and/or processor 105p using program code stored in memory 105m. The means for storing the position information associated with the second wireless communication point may include, e.g., database 102 and/or memory 105m. The mobile device 100 may further include means for retrieving the position information associated with the second wireless communication point, which may include, e.g., database access unit 109 and/or processor 105p using program code stored in memory 105m to access database 102 or server 120 through wireless interface 104. Means for using the position information in an application may include, e.g., SPS unit 107 and/or processor 105p using program code stored in memory 105m, e.g., employing geofencing and/or obtaining local weather conditions or any other position related application. The mobile device may further include means for using the position information associated with the second wireless communication point and stored position uncertainty data associated with a third wireless communication point to determine a second position information for the third wireless communication point, which may be, e.g., the position information determination unit 103 and/or the database access unit 109 and/or processor 105p using program code stored in memory 105m and database 102 or server 120. The mobile device may further include means for determining a plurality of positions of a corresponding plurality of wireless communication points from a plurality of wireless signals received from the plurality of wireless communication points which may include, e.g., the wireless interface 104, the position information determination unit 103 and/or the database access unit 109 and/or processor 105p using program code stored in memory 105m and database 102 or server 120. Means for determining associated position uncertainties for the second wireless communication point with respect to each of the plurality of positions may include, e.g., the position information determination unit 103 and/or processor 105p using program code stored in memory 105m. Means for using the plurality of positions and associated positioned uncertainties to determine the uncertainty region for the second wireless communication point may include, e.g., the position information determination unit 103 and/or processor 105p using program code stored in memory 105m.

Thus, the mobile device 100 may include means for receiving a first wireless signal from a first wireless communication point which may include, e.g., the wireless interface 104. Means for retrieving position information associated with the first wireless communication point, wherein the position information associated with the first wireless communication point is based on position data broadcast by a second wireless communication point may include the database access unit 109 and/or processor 105p using program code stored in memory 105m and database 102 or server 120. Means for using the position information associated with the first wireless communication point in an application may include, e.g., SPS unit 107 and/or processor 105p using program code stored in memory 105m, e.g., employing geofencing and/or obtaining local weather conditions or any other position related application.

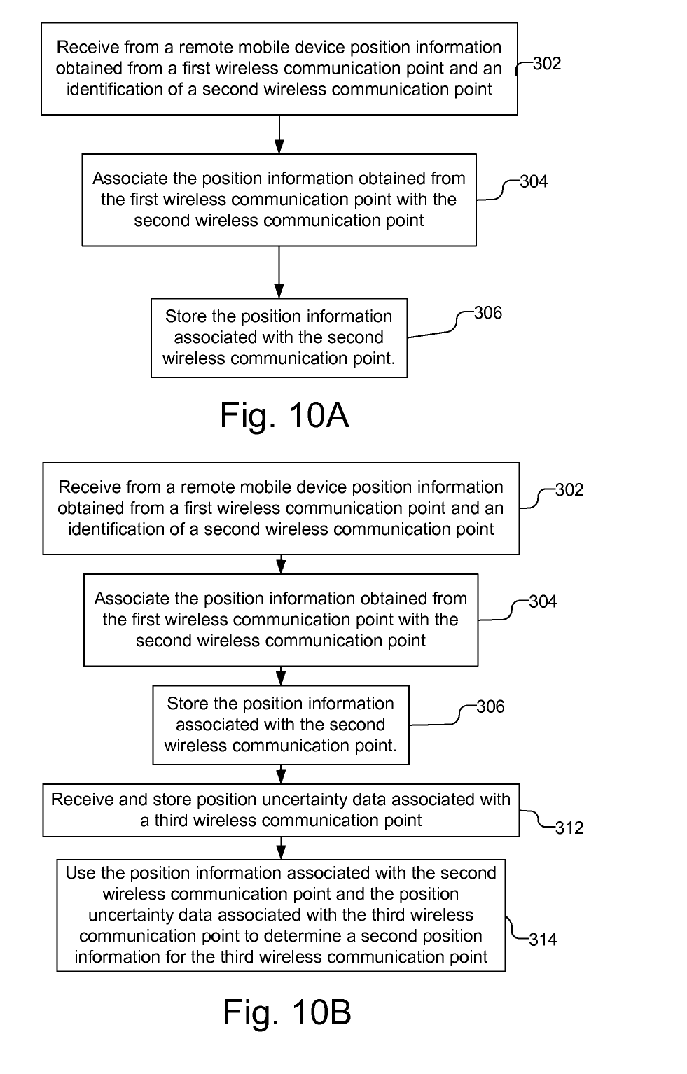

Additionally, the server 120, shown in FIG. 1, may be used to generate a database of position information, e.g., using crowdsourcing, as discussed herein. FIG. 10A is a flow chart illustrating method of generating a database of position information with the server 120. As illustrated, position information obtained from a first wireless communication point is received from a remote mobile device (302). Additionally, identification of a second wireless communication point is also received from the remote mobile device (302). The second wireless communication point may be in the same or different wireless network as the first wireless communication point. The second wireless communication point is accessed by the remote mobile device. The second wireless communication point may be accessed at approximately the same time as the first wireless communication point. The first wireless communication point and the second wireless communication point may be e.g., a wireless network base station, an access point, or a femto cell. The position information obtained from the first wireless communication point is associated with the second wireless communication point (304). The position information associated with the second wireless communication point is stored (306). If a request is received for the position information associated with the second wireless communication point, the position information associated with the second wireless communication point may then be retrieved and transmitted. The position information may include a position for the first wireless communication point and a position uncertainty for the second wireless communication point with respect to the position for the first wireless communication point. Alternatively, the position information received from the remote mobile device may be only the position for the first wireless communication point, wherein the server obtains a first distance between the remote mobile device and the first wireless communication point, obtains a second distance between the remote mobile device and the second wireless communication point; and combines the first distance and the second distance to generate a position uncertainty for the second wireless communication point with respect to the position for the first wireless communication point. The first distance and second distance may be obtained by receiving signal characteristics for the first wireless communication point and the second wireless communication point from the remote mobile device and determining the distances as illustrated in FIG. 6. Alternatively, the mobile device may determine and transmit the first distance and second distance to the server 120.

FIG. 10B is a flow chart illustrating another method of generating a database of position information with the server 120, which is similar to that shown in FIG. 10A, like designated elements being the same. As illustrated in FIG. 10B, the method further includes receiving and storing position uncertainty data associated with a third wireless communication point (312). The position information associated with the second wireless communication point and the position uncertainty data associated with the third wireless communication point is used to determine a second position information for the third wireless communication point (314). The second position information may be the position for the first wireless communication point and a second position uncertainty for the third wireless communication point with respect to the position for the first wireless communication point.

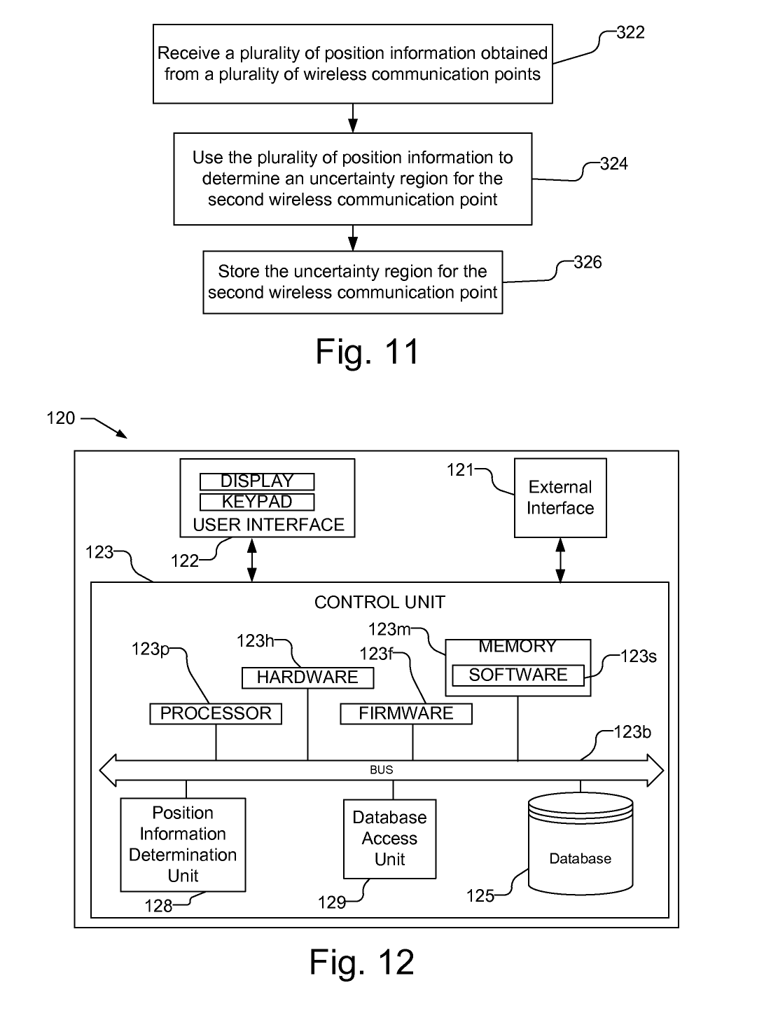

As illustrated in FIG. 11, the server may perform a method similar to that shown in FIG. 7 to determine an uncertainty region for the second wireless communication point. As illustrated in FIG. 11, a plurality of position information that is obtained from a plurality of wireless communication points is received from the remote mobile device (322). The plurality of position information is used to determine an uncertainty region for the second wireless communication point (324) and the uncertainty region for the second wireless communication point is stored (326). By way of example, the position information may be positions for the different wireless communication points and associated position uncertainties for the second wireless communication point with respect to the positions the different wireless communication points. Alternatively, the position information may be positions of the different wireless communication points and corresponding position uncertainty data associated with the second wireless communication point, where the corresponding position uncertainty data is used to determine associated position uncertainties for the second wireless communication point with respect to the positions the different wireless communication points.

FIG. 12 is a block diagram of the server 120 capable of using position information from a first wireless communication point with a second wireless communication point, e.g., to generate a database that associates the position information with the second wireless communication point. The server 120 includes an external interface 121 that is used to communicate with the mobile device 100 to receive position information as well as to receive requests for position information and to respond appropriately. The server 120 may further include a user interface 122 that may include e.g., a display, as well as a keypad or other input device through which the user can input information into the server 120.

The external interface 121 may be a wired interface to a router (not shown) or a wireless interface used in any various wireless communication networks such as a wireless wide area network (WWAN), a wireless local area network (WLAN), a wireless personal area network (WPAN), and so on. The term “network” and “system” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, Long Term Evolution (LTE), and so on. A CDMA network may implement one or more radio access technologies (RATs) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth® network, an IEEE 802.15x, or some other type of network. Moreover, any combination of WWAN, WLAN and/or WPAN may be used.

The server 120 also includes a control unit 123 that is connected to and communicates with the external interface 121. The control unit 123 may be provided by a bus 123b, processor 123p and associated memory 123m, hardware 123h, firmware 123f, and software 123s. The control unit 123 is further illustrated as including a database 125, which may be the storage element for storing position information, or alternatively, memory 123m may be used to store the position information, e.g., while transmitting the position information to a remote mobile device 100 (FIG. 1) using the external interface 121. The control unit 123 further includes a position information determination unit 128, which may determine the position information and identification of wireless communication points from the information received from the remote mobile devices through the external interface 121. For example, the position information determination unit 128 may simply receive the position of the wireless communication point from the remote mobile device 100. The position information determination unit 128 may further receive a position uncertainty from the remote mobile device 100 or may determine the position uncertainty based on distances to the first wireless communication point and the second wireless communication point, e.g., using a measured RSSI and a signal power model, and/or travel time. The position information determination unit 128 may further determine an uncertainty region for a wireless communication point using a plurality of positions and associated positioned uncertainties as discussed above. The database access unit 129 may associate determined position information from a first wireless communication point with the identify of a second wireless communication point and store the position information associated with the second wireless communication point in the database 125 and may access the database 125 to retrieve position information as necessary.

The position information determination unit 128 and database access unit 129 are illustrated separately from processor 123p for clarity, but may be part of the processor 123p or implemented in the processor based on instructions in the software 123s which is run in the processor 123p. Moreover, database 125 is illustrated as being within the control unit 123 and coupled directly to bus 123b, but may be external to the server 120 if desired.

It will be understood as used herein that the processor 123p can, but need not necessarily include, one or more microprocessors, embedded processors, controllers, application specific integrated circuits (ASICs), digital signal processors (DSPs), and the like. The term processor is intended to describe the functions implemented by the system rather than specific hardware. Moreover, as used herein the term “memory” refers to any type of computer storage medium, including long term, short term, or other memory associated with the mobile device, and is not to be limited to any particular type of memory or number of memories, or type of media upon which memory is stored.

The methodologies described herein may be implemented by various means depending upon the application. For example, these methodologies may be implemented in hardware 123h, firmware 123f, software 123s, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in memory 123m and executed by the processor 123p. Memory 123m may be implemented within or external to the processor 123p. If implemented in firmware and/or software, the functions may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Thus, the server 120 includes means for receiving from a remote mobile device position information obtained from a first wireless communication point and an identification of a second wireless communication point that is accessed by the remote mobile device, which may be, e.g., the external interface 121. Means for associating the position information obtained from the first wireless communication point with the second wireless communication point may be, e.g., the database access unit 129 and/or processor 123p using program code stored in memory 123m. Means for storing the position information associated with the second wireless communication point may be, e.g., the database 125. The server may further include means for receiving a request for the position information associated with the second wireless communication point, which may be, e.g., the external interface 121. Means for transmitting the position information associated with the second wireless communication point, which may be, e.g., the external interface 121. The server may include means for obtaining a first distance between the remote mobile device and the first wireless communication point, which may be e.g., the external interface 121 or the position information determination unit 128 and/or processor 123p using program code stored in memory 123m. Means for obtaining a second distance between the remote mobile device and the second wireless communication point may be e.g., the external interface 121 or the position information determination unit 128 and/or processor 123p using program code stored in memory 123m. Means for combining the first distance and the second distance to generate a position uncertainty for the second wireless communication point with respect to the position first wireless communication point may be, e.g., the position information determination unit 128 and/or processor 123p using program code stored in memory 123m. The server 120 may include means for receiving and storing position uncertainty data associated with a third wireless communication point, which may include the external interface 121, the database access unit 129 and/or processor 123p using program code stored in memory 123m and database 125. Means for using the position information associated with the second wireless communication point and the position uncertainty data associated with the third wireless communication point to determine a second position information for the third wireless communication point may include, e.g., the position information determination unit 128 and/or processor 123p using program code stored in memory 123m. The server 120 may include means for receiving a plurality of position information obtained from a plurality of wireless communication points, which may include the external interface 121. Means for using the plurality of position information to determine an uncertainty region for the second wireless communication point may include, e.g., the position information determination unit 128 and/or processor 123p using program code stored in memory 123m. Means for storing the uncertainty region for the second wireless communication point may include, e.g., the database 125.

Although the present invention is illustrated in connection with specific embodiments for instructional purposes, the present invention is not limited thereto. Various adaptations and modifications may be made without departing from the scope of the invention. Therefore, the spirit and scope of the appended claims should not be limited to the foregoing description.

What is claimed is:

1. A method comprising:
determining position information from a first wireless signal from a first wireless communication point;
receiving a second wireless signal from a second wireless communication point;
associating the position information with the second wireless communication point; and
storing the position information associated with the second wireless communication point.

2. The method of claim 1, wherein the first wireless communication point and the second wireless communication point are in different wireless networks.

3. The method of claim 1, wherein the second wireless signal is received at approximately the same time as the first wireless signal.

4. The method of claim 1, further comprising uploading the position information associated with the second wireless communication point to a server.

5. The method of claim 1, further comprising:
retrieving the position information associated with the second wireless communication point; and
using the position information in an application.

6. The method of claim 1, wherein the first wireless communication point and the second wireless communication point comprise at least one of a wireless network base station, an access point, and a femto cell.

7. The method of claim 1, wherein the position information comprises a position for the first wireless communication point and a position uncertainty for the second wireless communication point with respect to the position for the first wireless communication point.

8. The method of claim 7, wherein the position uncertainty for the second wireless communication point with respect to the position for the first wireless communication point is based on a first distance to the first wireless communication point and a second distance to the second wireless communication point.

9. The method of claim 8, further comprising determining the position uncertainty comprising:
determining a first signal characteristic for the first wireless signal, the first signal characteristic comprising at least one of a received signal strength indicator (RSSI) and a travel time;
using the first signal characteristic to determine the first distance to the first wireless communication point;
determining a second signal characteristic for the second wireless signal;
using the second signal characteristic to determine the second distance to the second wireless communication point; and
combining the first distance and the second distance to generate the position uncertainty for the second wireless communication point with respect to the position for the first wireless communication point.

10. The method of claim 8, further comprising:
using the position information associated with the second wireless communication point and position uncertainty data associated with a third wireless communication point to determine a second position information for the third wireless communication point, wherein the second position information comprises the position for the first wireless communication point and a second position uncertainty for the third wireless communication point based on the position uncertainty for the second wireless communication point and a third distance to the third wireless communication point.

11. The method of claim 1, wherein the position information comprises an uncertainty region, the method further comprising determining an uncertainty region comprising:
determining a plurality of positions of a corresponding plurality of wireless communication points from a plurality of wireless signals received from the plurality of wireless communication points;
determining associated position uncertainties for the second wireless communication point with respect to each of the plurality of positions; and
using the plurality of positions and associated positioned uncertainties to determine the uncertainty region for the second wireless communication point.

12. The method of claim 1, wherein the position information for the first wireless communication point is determined using a database or is contained within the first wireless signal.

13. A mobile device comprising:
a wireless interface capable of receiving a first wireless signal from a first wireless communication point and capable of communicating with a second wireless communication point;
a storage element; and
a processor coupled the storage element and the wireless interface, the processor configured to determine position information from the first wireless signal, associate the position information with the second wireless communication point, and to store the position information associated with the second wireless communication point in the storage element.

14. The mobile device of claim 13, wherein the first wireless communication point and the second wireless communication point are in different wireless networks.

15. The mobile device of claim 13, wherein the second wireless signal is received at approximately the same time as the first wireless signal.

16. The mobile device of claim 13, wherein the processor is further configured to cause the wireless interface to upload the position information associated with the second wireless communication point to a server.

17. The mobile device of claim 13, further comprising:
wherein the processor is further configured to retrieve the position information associated with the second wireless communication point, and use the position information in an application.

18. The mobile device of claim 13, wherein the first wireless communication point and the second wireless communication point comprise at least one of a wireless network base station, an access point, and a femto cell.

19. The mobile device of claim 13, wherein the processor is configured to determine the position information by being configured to determine from the first wireless signal a position for the first wireless communication point and a position uncertainty for the second wireless communication point with respect to the position for the first wireless communication point.

20. The mobile device of claim 19, wherein the processor is configured to determine the position uncertainty for the second wireless communication point with respect to the position for the first wireless communication point based on a first distance to the first wireless communication point and a second distance to the second wireless communication point.

21. The mobile device of claim 20, wherein the processor is further configured to determine the position uncertainty by being configured to:
determine a first signal characteristic for the first wireless signal, the first signal characteristic comprising at least one of a received signal strength indicator (RSSI) and a travel time;
use the first signal characteristic to determine the first distance to the first wireless communication point;
determine a second signal characteristic for a second wireless signal received from the second wireless communication point;
use the second signal characteristic to determine the second distance to the second wireless communication point;
combine the first distance and the second distance to generate the position uncertainty for the second wireless communication point with respect to the position for the first wireless communication point.

22. The mobile device of claim 20, wherein the processor is further configured to use the position information associated with the second wireless communication point and position uncertainty data associated with a third wireless communication point stored in the storage element to determine a second position information for the third wireless communication point, wherein the second position information comprises the position for the first wireless communication point and a second position uncertainty for the third wireless communication point based on the position uncertainty for the second wireless communication point and a third distance to the third wireless communication point.

23. The mobile device of claim 13, wherein the processor is configured to determine the position information by being configured to determine an uncertainty region by being configured to:
determine a plurality of positions of a corresponding plurality of wireless communication points from a plurality of wireless signals received by the wireless interface from the plurality of wireless communication points;
determine associated position uncertainties for the second wireless communication point with respect to each of the plurality of positions; and
use the plurality of positions and associated positioned uncertainties to determine the uncertainty region for the second wireless communication point.

24. The mobile device of claim 13, wherein the processor is configured to determine the position information for the first wireless communication point from the storage element or from the first wireless signal.

25. A mobile device comprising:
means for determining position information from a first wireless signal from a first wireless communication point;
means for receiving a second wireless signal from a second wireless communication point;
means for associating the position information with the second wireless communication point; and
means for storing the position information associated with the second wireless communication point.

26. The mobile device of claim 25, further comprising:
means for retrieving the position information associated with the second wireless communication point; and
means for using the position information in an application.

27. The mobile device of claim 25, wherein the position information comprises a position for the first wireless communication point and a position uncertainty for the second wireless communication point with respect to the position for the first wireless communication point.

28. The mobile device of claim 27, wherein the position uncertainty for the second wireless communication point with respect to the position for the first wireless communication point is based on a first distance to the first wireless communication point and a second distance to the second wireless communication point.

29. The mobile device of claim 28, further comprising:
means for using the position information associated with the second wireless communication point and position uncertainty data associated with a third wireless communication point to determine a second position information for the third wireless communication point, wherein the second position information comprises the position for the first wireless communication point and a second position uncertainty for the third wireless communication point based on the position uncertainty for the second wireless communication point and a third distance to the third wireless communication point.

30. The mobile device of claim 25, wherein the position information comprises an uncertainty region, the mobile device further comprising:
means for determining a plurality of positions of a corresponding plurality of wireless communication points from a plurality of wireless signals received from the plurality of wireless communication points;
means for determining associated position uncertainties for the second wireless communication point with respect to each of the plurality of positions; and
means for using the plurality of positions and associated positioned uncertainties to determine the uncertainty region for the second wireless communication point.

31. A non-transitory computer-readable medium including program code stored thereon, comprising:
program code to determine position information from a first wireless signal from a first wireless communication point;
program code to receive a second wireless signal from a second wireless communication point;
program code to associate the position information with the second wireless communication point; and
program code to store the position information associated with the second wireless communication point.

32. The non-transitory computer-readable medium of claim 31, further comprising:
program code to retrieve the position information associated with the second wireless communication point; and
program code to use the position information in an application.

33. The non-transitory computer-readable medium of claim 31, wherein the position information comprises a position for the first wireless communication point and a position uncertainty for the second wireless communication point with respect to the position for the first wireless communication point.

34. The non-transitory computer-readable medium of claim 33, wherein the position uncertainty for the second wireless communication point with respect to the position for the first wireless communication point is based on a first distance to the first wireless communication point and a second distance to the second wireless communication point.

35. A method comprising:
receiving a first wireless signal from a first wireless communication point;
retrieving position information associated with the first wireless communication point, wherein the position information associated with the first wireless communication point is based on position data broadcast by a second wireless communication point; and
using the position information associated with the first wireless communication point in an application.

36. The method of claim 35, wherein the first wireless communication point and the second wireless communication point are in different wireless networks.

37. The method of claim 35, wherein using the position information associated with the first wireless communication point in an application comprises using the position information to assist in obtaining a position fix from a satellite, geofencing or obtaining local weather conditions.

38. The method of claim 35, wherein the position information is retrieved from one of a local database and a server.

39. The method of claim 35, wherein the first wireless communication point and the second wireless communication point comprises at least one of a wireless network base station, an access point, and a femto cell.

40. The method of claim 35, wherein the position information comprises a position for the second wireless communication point and a position uncertainty for the first wireless communication point with respect to the position for the second wireless communication point.

41. The method of claim 35, wherein the position information comprises an uncertainty region defined by a plurality of positions for a plurality of wireless communication points and a plurality of position uncertainties for the first wireless communication point with respect to the plurality of positions.

42. A mobile device comprising:
a wireless interface capable of receiving a first wireless signal from a first wireless communication point; and
a processor coupled the wireless interface, the processor configured to retrieve position information associated with the first wireless communication point, wherein the position information associated with the first wireless communication point is based on position data broadcast by a second wireless communication point, and use the position information associated with the first wireless communication point in an application.

43. The mobile device of claim 42, wherein the processor is configured to use the position information associated with the first wireless communication point in an application by being configured to use the position information to assist in obtaining a position fix from a satellite positioning system using a satellite positioning system receiver coupled to the processor, geofencing, or obtaining local weather conditions.

44. The mobile device of claim 42, wherein the processor is configured to retrieve the position information from one of a local database and a server using the wireless interface.

45. The mobile device of claim 42, wherein the first wireless communication point and the second wireless communication point comprises at least one of a wireless network base station, an access point, and a femto cell.

46. The mobile device of claim 42, wherein the position information comprises at least one of a position for the second wireless communication point with a position uncertainty for the first wireless communication point with respect to the position of the second wireless communication point and an uncertainty region defined by a plurality of positions for a plurality of wireless communication points and a plurality of position uncertainties for the first wireless communication point with respect to the plurality of positions.

47. A mobile device comprising:
means for receiving a first wireless signal from a first wireless communication point;
means for retrieving position information associated with the first wireless communication point, wherein the position information associated with the first wireless communication point is based on position data broadcast by a second wireless communication point; and
means for using the position information associated with the first wireless communication point in an application.

48. The mobile device claim 47, wherein the means for using the position information associated with the first wireless communication point in an application uses the position information to assist in obtaining a position fix from a satellite positioning system, geofencing, or obtaining local weather conditions.

49. The mobile device claim 47, wherein the means for retrieving position information retrieves the position information from one of a local database and a server.

50. The mobile device claim 47, wherein the position information comprises at least one of a position for the second wireless communication point with a position uncertainty for the first wireless communication point with respect to the position for the second wireless communication point and an uncertainty region defined by a plurality of positions for a plurality of wireless communication points and a plurality of position uncertainties for the first wireless communication point with respect to the plurality of positions.

51. A non-transitory computer-readable medium including program code stored thereon, comprising:
program code to receive a first wireless signal from a first wireless communication point;
program code to retrieve position information associated with the first wireless communication point, wherein the position information associated with the first wireless communication point is based on position data broadcast by a second wireless communication point; and
program code to use the position information associated with the first wireless communication point in an application.

52. The non-transitory computer-readable medium of claim 51, wherein the position information comprises at least one of a position for the second wireless communication point with a position uncertainty for the first wireless communication point with respect to the position for the second wireless communication point and an uncertainty region defined by a plurality of positions for a plurality of wireless communication points and a plurality of position uncertainties for the first wireless communication point with respect to the plurality of positions.

53. A method comprising:
receiving from a remote mobile device position information obtained from a first wireless communication point and an identification of a second wireless communication point that is accessed by the remote mobile device;
associating the position information obtained from the first wireless communication point with the second wireless communication point; and
storing the position information associated with the second wireless communication point.

54. The method of claim 53, wherein the first wireless communication point and the second wireless communication point are in different wireless networks.

55. The method of claim 53, wherein the second wireless communication point is accessed by the remote mobile device at approximately the same time as the first wireless communication point.

56. The method of claim 53, further comprising:
receiving a request for the position information associated with the second wireless communication point; and
transmitting the position information associated with the second wireless communication point.

57. The method of claim 53, wherein the first wireless communication point and the second wireless communication point comprise at least one of a wireless network base station, an access point, and a femto cell.

58. The method of claim 53, wherein the position information comprises a position for the first wireless communication point and a position uncertainty for the second wireless communication point with respect to the position for the first wireless communication point.

59. The method of claim 53, wherein the position information comprises a position for the first wireless communication point, the method further comprising:
obtaining a first distance between the remote mobile device and the first wireless communication point;
obtaining a second distance between the remote mobile device and the second wireless communication point; and
combining the first distance and the second distance to generate a position uncertainty for the second wireless communication point respect to the position for the first wireless communication point.

60. The method of claim 53, further comprising:
receiving and storing position uncertainty data associated with a third wireless communication point; and
using the position information associated with the second wireless communication point and the position uncertainty data associated with the third wireless communication point to determine a second position information for the third wireless communication point, wherein the second position information comprises a position for the first wireless communication point and a second position uncertainty for the third wireless communication point with respect to the position of the first wireless communication point.

61. The method of claim 53, further comprising:
receiving a plurality of position information obtained from a plurality of wireless communication points;
using the plurality of position information to determine an uncertainty region for the second wireless communication point; and
storing the uncertainty region for the second wireless communication point.

62. The method of claim 61, wherein each of the position information comprises a position of a different wireless communication point and an associated position uncertainty for the second wireless communication point with respect to the position of the different wireless communication point.

63. The method of claim 61, wherein each of the position information comprises a position of a different wireless communication point and corresponding position uncertainty data associated with the second wireless communication point, the method further comprising using the corresponding position uncertainty data to determine an associated position uncertainty for the second wireless communication point with respect to the position of the different wireless communication point.

64. A server comprising:
an external interface for communication with remote mobile devices;
a storage element; and
a processor coupled to the external interface and the storage element, the processor configured to receive from a remote mobile device through the external interface position information obtained from a first wireless communication point and an identification of a second wireless communication point that is accessed by the remote mobile device; associate the position information obtained from the first wireless communication point with the second wireless communication point; and store the position information associated with the second wireless communication point in the storage element.

65. The server of claim 64, wherein the processor is further configured to:
receive through the external interface a request for the position information associated with the second wireless communication point; and
transmit through the external interface the position information associated with the second wireless communication point.

66. The server of claim 64, wherein the position information comprises a position for the first wireless communication point and a position uncertainty for the second wireless communication point with respect to the position for the first wireless communication point.

67. The server of claim 64, wherein the position information comprises a position for the first wireless communication point, the processor further configured to:
obtain a first distance between the remote mobile device and the first wireless communication point;
obtain a second distance between the remote mobile device and the second wireless communication point; and
combine the first distance and the second distance to generate a position uncertainty for the second wireless communication point with respect to the position for the first wireless communication point.

68. The server of claim 64, wherein the processor is further configured to:
receive and store position uncertainty data associated with a third wireless communication point; and
use the position information associated with the second wireless communication point and the position uncertainty data associated with the third wireless communication point to determine a second position information for the third wireless communication point, wherein the second position information comprises a position for the first wireless communication point and a second position uncertainty for the third wireless communication point with respect to the position for the first wireless communication point.

69. The server of claim 64, wherein the processor is further configured to:
receive a plurality of position information obtained from a plurality of wireless communication points;
use the plurality of position information to determine an uncertainty region for the second wireless communication point; and
store the uncertainty region for the second wireless communication point in the storage element.

70. A server comprising:
means for receiving from a remote mobile device position information obtained from a first wireless communication point and an identification of a second wireless communication point that is accessed by the remote mobile device;
means for associating the position information obtained from the first wireless communication point with the second wireless communication point; and
means for storing the position information associated with the second wireless communication point.

71. The server of claim 70, further comprising:
means for receiving a request for the position information associated with the second wireless communication point; and
means for transmitting the position information associated with the second wireless communication point.

72. The server of claim 70, wherein the position information comprises a position for the first wireless communication point and a position uncertainty for the second wireless communication point with respect to the position for the first wireless communication point.

73. The server of claim 70, wherein the position information comprises a position for the first wireless communication point, the server further comprising:
means for obtaining a first distance between the remote mobile device and the first wireless communication point;
means for obtaining a second distance between the remote mobile device and the second wireless communication point; and
means for combining the first distance and the second distance to generate a position uncertainty for the second wireless communication point with respect to the position for the first wireless communication point.

74. The server of claim 70, further comprising:
means for receiving and storing position uncertainty data associated with a third wireless communication point; and
means for using the position information associated with the second wireless communication point and the position uncertainty data associated with the third wireless communication point to determine a second position information for the third wireless communication point, wherein the second position information comprises a position for the first wireless communication point and a second position uncertainty for the third wireless communication point with respect to the position for the first wireless communication point.

75. The server of claim 70, further comprising:
means for receiving a plurality of position information obtained from a plurality of wireless communication points;
means for using the plurality of position information to determine an uncertainty region for the second wireless communication point; and
means for storing the uncertainty region for the second wireless communication point.

76. A non-transitory computer-readable medium including program code stored thereon, comprising:
program code to receive from a remote mobile device position information obtained from a first wireless communication point and an identification of a second wireless communication point that is accessed by the remote mobile device;
program code to associate the position information obtained from the first wireless communication point with the second wireless communication point; and
program code to store the position information associated with the second wireless communication point.

77. The non-transitory computer-readable medium of claim 76, further comprising:
program code to receive a request for the position information associated with the second wireless communication point; and
program code to transmit the position information associated with the second wireless communication point.

78. The non-transitory computer-readable medium of claim 76, wherein the position information comprises a position for the first wireless communication point and a position uncertainty for the second wireless communication point with respect to the position for the first wireless communication point.

79. The non-transitory computer-readable medium of claim 76, wherein the position information comprises a position for the first wireless communication point, the non-transitory computer-readable medium further comprising:
program code to obtain a first distance between the remote mobile device and the first wireless communication point;
program code to obtain a second distance between the remote mobile device and the second wireless communication point; and
program code to combine the first distance and the second distance to generate a position uncertainty for the second wireless communication point with respect to the position for the first wireless communication point.

80. The non-transitory computer-readable medium of claim 76, further comprising:
program code to receive and storing position uncertainty data associated with a third wireless communication point; and
program code to use the position information associated with the second wireless communication point and the position uncertainty data associated with the third wireless communication point to determine a second position information for the third wireless communication point, wherein the second position information comprises a position for the first wireless communication point and a second position uncertainty for the third wireless communication point with respect to the position for the first wireless communication point.

81. The non-transitory computer-readable medium of claim 76, further comprising:
program code to receive a plurality of position information obtained from a plurality of wireless communication points;
program code to use the plurality of position information to determine an uncertainty region for the second wireless communication point; and
program code to store the uncertainty region for the second wireless communication point.
